(19) United States
(12) Patent Application Publication
(10) Pub. No.: US 2025/0348793 A1
(43) Pub. Date: Nov. 13, 2025

(54) MACHINE LEARNING PROGRAM, METHOD, AND DEVICE

(71) Applicant: Fujitsu Limited, Kawasaki-shi (JP)

(72) Inventor: FAN YANG, Edogawa (JP)

(73) Assignee: Fujitsu Limited, Kawasaki-shi (JP)

(21) Appl. No.: 19/279,194

(22) Filed: Jul. 24, 2025

Related U.S. Application Data
(63) Continuation of application No. PCT/JP2023/007396, filed on Feb. 28, 2023.

(51) Int. Cl. G06N 20/00; G06T 7/20; G06V 20/70

(52) U.S. Cl. CPC G06N 20/00; G06T 7/20; G06V 20/70

(57) ABSTRACT

A machine learning device includes a processor executing a procedure including: generating a combined label obtained by combining a first label and a second label for each of frames between a first representative frame to which the first label is added and a second representative frame to which the second label is added, in a video in which a label indicating a type of a motion of a person is added to a representative frame included in each section divided for each type of the motion of the person in the video including a plurality of frames; and training a machine learning model, which estimates a label of each frame included in an input video, to maximize a probability that the label of each frame estimated by the machine learning model is the first label or the second label included in the combined label generated for each of the frames.

### CROSS-REFERENCE TO RELATED APPLICATION

This application is a continuation application of International Application No. PCT/JP2023/007396, filed Feb. 28, 2023, the disclosure of which is incorporated herein by reference in its entirely.

### FIELD

The embodiments discussed herein are related to a machine learning program, a machine learning method, and a machine learning device.

### BACKGROUND

A motion of a person included in a video is estimated using a machine learning model. In order to train such a machine learning model, a video to which a correct label indicating the type (class) of the motion is added is used as training data. An ideal case of the training data is one in which a correct label is added to each frame (hereinafter, referred to as “full annotation”). However, there are the following two problems in preparing the training data of the full annotation. The first is that it takes a huge work cost to add a correct label to each frame. The second is that there is a possibility that a temporal boundary at which types of motions are switched becomes ambiguous, and there is a possibility that different annotators add various labels to frames near the boundary. In this case, data may be biased.

Accordingly, instead of adding labels to all frames, a technique called a timestamp annotation has been proposed in which a label is added to one frame among a plurality of frames included in a section indicating one motion. In this method, the work cost of adding labels is reduced as compared with the full annotation. This approach also reduces label mismatches at temporal boundaries because the annotator can select a reliable timestamp for labeling.

### Related Non-Patent Document

Z. Li, Y. Abu Farha, and J. Gall, “Temporal action segmentation from timestamp supervision,” in Proceedings of the IEEE/CVF Conference on Computer Vision and Pattern Recognition, 2021, pp. 8365-8374.

### SUMMARY

According to an aspect of the embodiments, a non-transitory recording medium storing a program executable by a computer to perform machine learning program processing, the processing comprising: generating a combined label obtained by combining a first label and a second label for each of frames between a first representative frame to which the first label is added and a second representative frame to which the second label is added, in a video in which a label indicating a type of a motion of a person is added to a representative frame included in each section divided for each type of the motion of the person in the video including a plurality of frames; and training a machine learning model, which estimates a label of each frame included in an input video, to maximize a probability that the label of each frame estimated by the machine learning model is the first label or the second label included in the combined label generated for each of the frames.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a machine learning device.

FIG. 2 is a schematic diagram illustrating an example of a training video.

FIG. 3 is a diagram for describing generation of a combined label.

FIG. 4 is a diagram for describing training of a machine learning model using the combined label.

FIG. 5 is a block diagram illustrating a schematic configuration of a computer functioning as a machine learning device.

FIG. 6 is a flowchart illustrating an example of machine learning processing.

FIG. 7 is a flowchart illustrating an example of estimation processing.

FIG. 8 is a diagram for describing comparison of estimation results between the present approach and Comparative Method 1.

FIG. 9 is a diagram for describing comparison of estimation results between the present approach and Comparative Method 2.

FIG. 10 is a diagram for describing an application example of the machine learning device according to the present embodiment to a scoring system of a gymnastics competition.

### DESCRIPTION OF EMBODIMENTS

Hereinafter, an example of an embodiment according to the disclosed technology will be described with reference to the drawings.

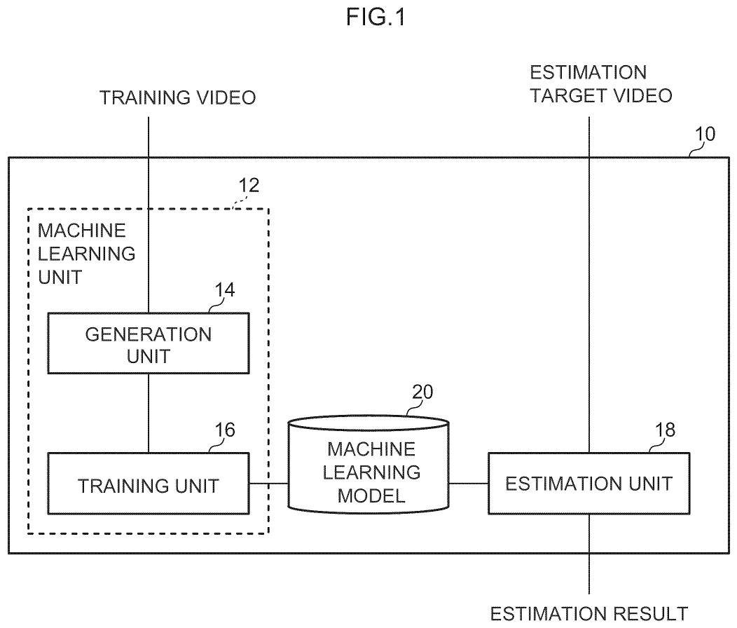

As illustrated in FIG. 1, a training video is input to a machine learning device 10 according to the present embodiment at the time of training a machine learning model 20, and an estimation target video is input at the time of estimating a motion.

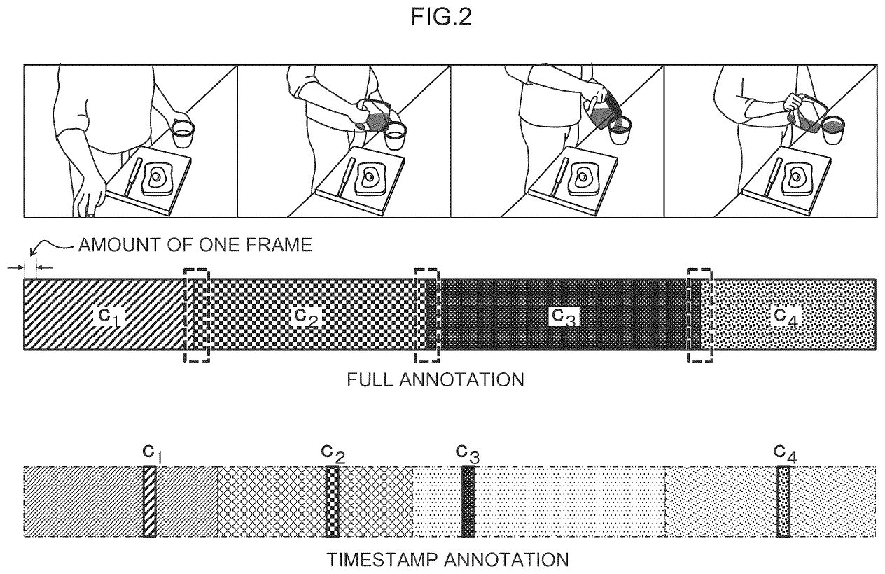

In the training video, a label indicating a type (class) of motion is added to some frames by a timestamp annotation. Here, the label added by the timestamp annotation will be described in comparison with the full annotation. FIG. 2 is a diagram schematically illustrating an example of the training video. The upper diagram in FIG. 2 is a schematic diagram in which some frames included in a video are arranged from left to right in time series, the middle diagram is a schematic diagram of a label added by a full annotation, and the lower diagram is a schematic diagram of a label added by a timestamp annotation. The schematic diagrams of the middle and lower labels indicate that the width illustrated in the leftmost part of the middle diagram corresponds to one frame, and a difference in label of each frame is indicated by a difference in hatching.

In the full annotation, labels are added to all frames included in the video. In FIG. 2, a frame group to which the same label (in the example of FIGS. 2, c₁, c₂, c₃, and c₄) is added is represented by a block. As described above, in the full annotation, there are problems that a work cost of adding labels is enormous, and a temporal boundary (a broken line portion in the middle diagram of FIG. 2) at which the type of motion is switched becomes ambiguous, and there is a possibility that a label mismatch due to an annotator occurs.

On the other hand, in the timestamp annotation, a label is added to only one frame among a plurality of frames included in a section indicating one motion. Thus, the work cost of adding labels is reduced, and there is no label mismatch at the temporal boundary. In the training of the machine learning model by the training video to which a label is added by the timestamp annotation, a pseudo label (a portion indicated by a two-dot chain line in the lower diagram of FIG. 2) is generated for a frame other than the frame to which the correct label is added. Since all labels that can be output by a machine learning label are candidates for this pseudo label, reliability that it is correct is low. Therefore, the estimation accuracy of the trained machine learning model is inferior to the machine learning model trained with the training video of the full annotation. Hereinafter, the training of the machine learning model by the training video to which a label is added by the timestamp annotation is referred to as “timestamp semi-supervised learning”.

Therefore, in the present embodiment, a combined label (details will be described later) having higher reliability than the pseudo label generated at the time of the timestamp semi-supervised learning is generated, and the machine learning model is trained. Hereinafter, the machine learning device 10 according to the present embodiment will be described in detail.

The machine learning device 10 functionally includes a machine learning unit 12 and an estimation unit 18 as illustrated in FIG. 1. The machine learning unit 12 further includes a generation unit 14 and a training unit 16. The machine learning model 20 is stored in a predetermined storage area of the machine learning device 10. The machine learning model 20 is a model that estimates a label of each frame included in the input video, and is, for example, a model such as a deep neural network.

The generation unit 14 acquires the training video input to the machine learning device 10. The generation unit 14 generates a combined label obtained by combining a first label and a second label for each frame between a first representative frame to which the first label is added and a second representative frame to which the second label is added in the acquired training video.

Specifically, the generation unit 14 adds the first label to each frame from the first representative frame toward the second representative frame up to the frame immediately before the second representative frame. The generation unit 14 adds the second label to each frame from the second representative frame toward the first representative frame up to the frame immediately before the first representative frame. Then, the generation unit 14 generates a combined label by combining a plurality of labels added to the respective frames. The representative frame is a frame to which a label by a timestamp annotation is added.

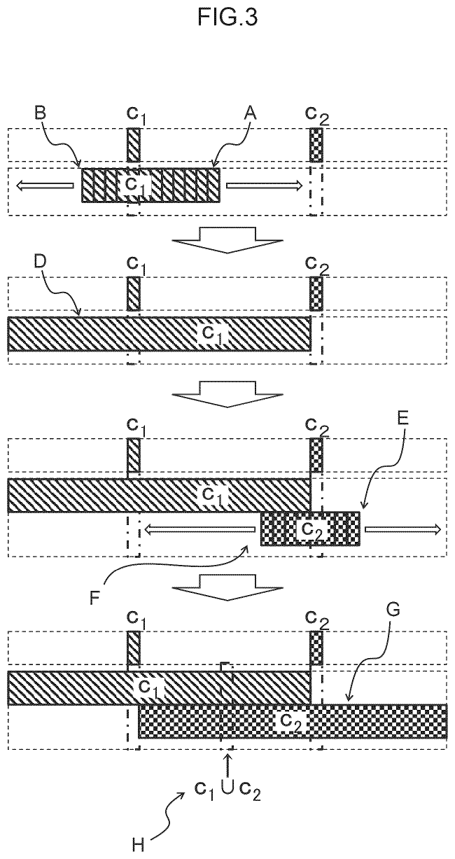

For example, as illustrated in A of FIG. 3, the generation unit 14 repeats adding the label c₁ to the next frame in chronological order from the frame to which the label c₁ by the timestamp annotation is added up to the frame immediately before the frame to which the label c₂ is added. As illustrated in B of FIG. 3, the generation unit 14 repeats adding the label c₁ to the previous frame in the reverse order of time series from the frame to which the label c₁ is added up to the head frame. Thus, as illustrated in D of FIG. 3, the label c₁ is added to each frame from the head frame to the frame immediately before the frame to which the label c₂ is added.

Similarly, as illustrated in E of FIG. 3, the generation unit 14 repeats adding the label c₂ to the next frame in chronological order from the frame to which the label c₂ is added up to the frame immediately before the frame to which the label c₃ is added (not illustrated). As illustrated in F of FIG. 3, the generation unit 14 repeats adding the label c₂ to the previous frame in the reverse order of time series from the frame to which the label c₂ is added up to the frame immediately after the frame to which the label c₁ is added. Thus, as illustrated in G of FIG. 3, the label c₂ is added to each frame from the frame immediately after the frame to which the label c₁ is added to the frame immediately before the frame to which the label c₃ is added. The generation unit 14 executes the above processing on all the frames to which the labels by the timestamp annotations have been added, that is, the representative frames. Then, for example, the generation unit 14 generates a combined label c1Uc2 obtained by combining the added labels c₁ and c₂ for the frame illustrated in H of FIG. 3.

The training unit 16 trains the machine learning model 20 to maximize the probability that the label of each frame is the first label or the second label included in the combined label generated for that frame. In the present embodiment, the machine learning model 20 estimates a probability that the label of each frame is each of a plurality of labels indicating the type of motion by a value from zero to one. Specifically, the training unit 16 trains the machine learning model 20 so as to minimize a loss function that becomes smaller as the sum of a probability that a label of a frame in which the combined label is generated is the first label and a probability that the label is the second label is closer to 1.

More specifically, in a case in which the number of frames of the training video is N_{frame} and the number of types of labels is N_{C}, the output Y (real number) of the machine learning model 20 is represented by a matrix of N_{frame}×N_{c}. Assuming that the output of one neuron of the machine learning model 20 is yᵢ, each element of the matrix Y is Y [i, f]=p(y_{i, f}), that is, a probability that the label of the frame f is cᵢ. p(y_{i, f}) is generally formulated by the following Formula (1).

$$\begin{matrix}[ Math . 1 ] & \\ p ( {y}_{i , f} ) = \frac{exp ( {y}_{i , f} )}{{\sum }_{j}^{{N}_{C}} exp ( {y}_{j , f} )} . & ( 1 )\end{matrix}$$

For example, by using a mean square error, the training unit 16 defines a loss function Lₐᵤ for minimizing the difference between the probability of the combined label based on the probability p(y_{i, f}) estimated by the machine learning model 20 and the true probability of the combined label as in the following Formula (2).

$$\begin{matrix}[ Math . 2 ] & \\ {ℒ}_{au} = \frac{1}{{N}_{frame}} {\sum }_{f}^{{N}_{frame}} {( \frac{{\sum }_{i}^{{N}_{C}^{pos}} exp ( {y}_{i , f} )}{{\sum }_{j}^{{N}_{C}} exp ( {y}_{j , f} )} - 1 )}^{2} & ( 2 )\end{matrix}$$

N_{C}^{pos} is the number of labels cᵢ included in the combined label, and the molecule in the parentheses on the right side of Formula (2) represents the sum of the probabilities p(y_{i, f}) estimated by the machine learning model 20 for the labels cᵢ included in the combined label. Since the denominator in the parentheses on the right side of Formula (2) is 1, the closer the numerator is to 1, the smaller the loss function Lₐᵤ becomes.

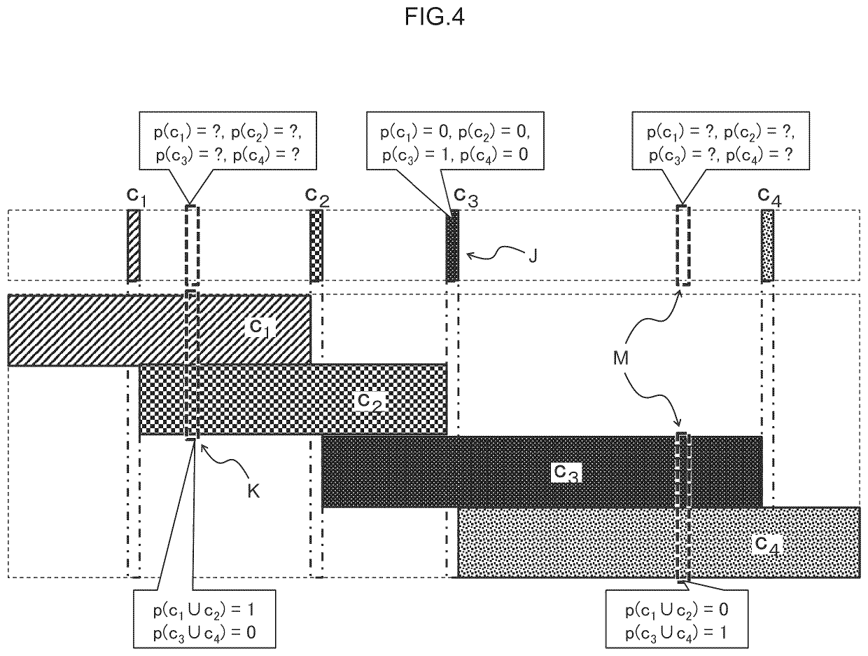

For example, as illustrated in FIG. 4, a case in which the machine learning model 20 is trained using a training video including a frame to which each of the labels c₁, c₂, c₃, and c₄ is added as a representative frame will be described. First, as a comparison, a case in which the timestamp semi-supervised learning is performed using the training video will be described. As in the case of the frame illustrated in J of FIG. 4, in the case of the representative frame to which the label c₃ is added, the probability estimated by the machine learning model 20 is trained to approach p(c1)=0, p(c2)=0, p(c3)=1, and p(c4)=0. However, as in the frames denoted by K and M in FIG. 4, in a frame that is not the representative frame, it is indefinite which of p(c1), p(c2), p(c3), and p(c4) is to be 1 and which is to be 0. Therefore, the training of the machine learning model 20 depends on the pseudo label with low reliability, and the estimation accuracy decreases.

On the other hand, in the present embodiment, for a frame illustrated in K of FIG. 4 in which the combined label c1Uc2 is generated, the probability estimated by the machine learning model 20 is trained to approach p(c1Uc2)=1 and p(c3Uc4)=0. For frames illustrated in M of FIG. 4 in which the combined label c3Uc4 is generated, the probabilities estimated by the machine learning model 20 are trained to approach p(c1Uc2)=0 and p(c3Uc4)=1. As described above, in the present embodiment, a loss function is used in which the sum of the probabilities of the labels included in the combined label approaches 1 and the sum of the probabilities of the labels not included in the combined label approaches 0. Thus, it is possible to generate a highly reliable combined label for frames other than the representative frame and train the machine learning model 20.

The training unit 16 stores the trained machine learning model 20 in a predetermined storage area of the machine learning device 10.

The estimation unit 18 acquires the estimation target video input to the machine learning device 10. The estimation unit 18 inputs the estimation target video to the trained machine learning model 20 and estimates a motion indicated by each frame included in the estimation target video. Specifically, based on the output Y[i, f] of the machine learning model, the estimation unit 18 estimates the motion indicated by the label ci with the maximum p(ci, f) as a motion of the frame f, and outputs the motion as the estimation result.

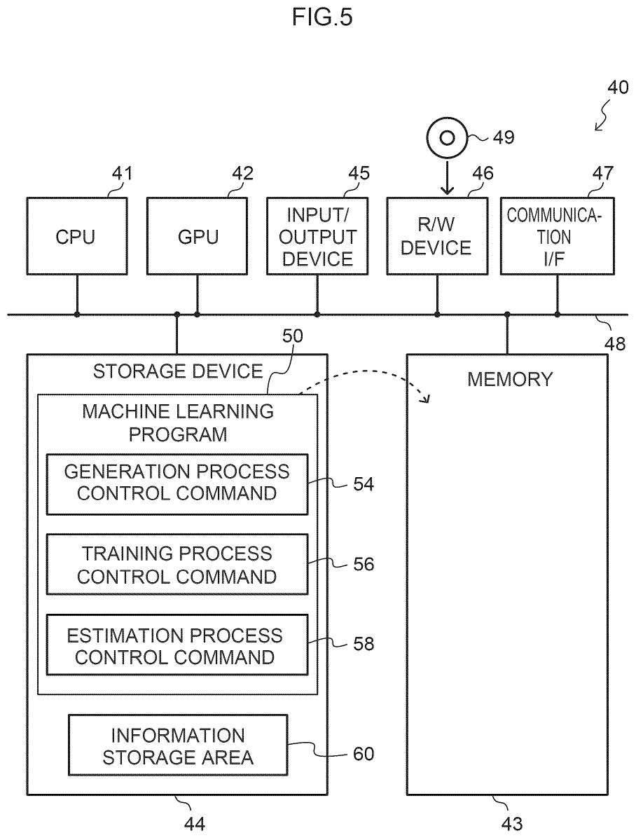

The machine learning device 10 may be realized by, for example, a computer 40 illustrated in FIG. 5. The computer 40 includes a central processing unit (CPU) 41, a graphics processing unit (GPU) 42, a memory 43 as a temporary storage area, and a nonvolatile storage device 44. The computer 40 includes an input/output device 45 such as an input device and a display device, and a read/write (R/W) device 46 that controls reading and writing of data with respect to the storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), a flash memory, or the like. The storage device 44 as a storage medium stores a machine learning program 50 for causing the computer 40 to function as the machine learning device 10. The machine learning program 50 includes a generation process control command 54, a training process control command 56, and an estimation process control command 58. The storage device 44 includes an information storage area 60 in which information constituting the machine learning model 20 is stored.

The CPU 41 reads the machine learning program 50 from the storage device 44, develops the program in the memory 43, and sequentially executes the control commands included in the machine learning program 50. The CPU 41 operates as the generation unit 14 illustrated in FIG. 1 by executing the generation process control command 54. The CPU 41 operates as the training unit 16 illustrated in FIG. 1 by executing the training process control command 56. The CPU 41 operates as the estimation unit 18 illustrated in FIG. 1 by executing the estimation process control command 58. The CPU 41 reads information from the information storage area 60 and develops the machine learning model 20 in the memory 43. Thus, the computer 40 that has executed the machine learning program 50 functions as the machine learning device 10. The CPU 41 that executes the program is hardware. A part of the program may be executed by the GPU 42.

Functions implemented by the machine learning program 50 may be implemented by, for example, a semiconductor integrated circuit, more specifically, an application specific integrated circuit (ASIC), a field-programmable gate array (FPGA), or the like.

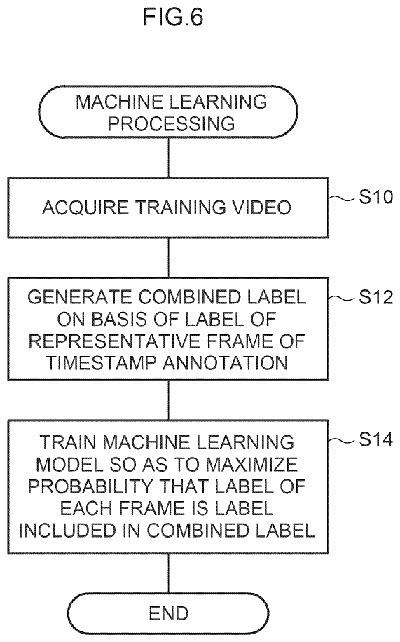

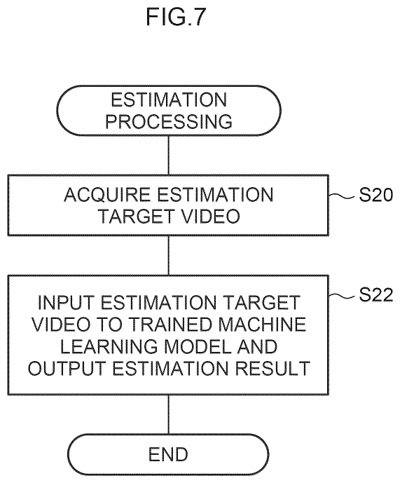

Next, an operation of the machine learning device 10 according to the present embodiment will be described. When the training video is input to the machine learning device 10 and the training of the machine learning model 20 is instructed, the machine learning device 10 executes the machine learning processing illustrated in FIG. 6. When the estimation target video is input to the machine learning device 10 and the motion estimation is instructed, the machine learning device 10 executes the estimation processing illustrated in FIG. 7. The machine learning processing is an example of a machine learning method of the disclosed technology.

First, the machine learning processing illustrated in FIG. 6 will be described.

In step S10, the generation unit 14 acquires the training video input to the machine learning device 10. Next, in step S12, the generation unit 14 adds the label of the representative frame added by the timestamp annotation to each frame up to the frame immediately before the adjacent representative frame in chronological order. The generation unit 14 adds the label of the representative frame added by the timestamp annotation to each frame up to the frame immediately after the adjacent representative frame in reverse chronological order. Then, for each frame, the generation unit 14 generates a combined label obtained by combining a plurality of labels added to the frame.

Next, in step S14, the training unit 16 trains the machine learning model 20 so as to maximize the probability that the label of each frame is the first label or the second label included in the combined label generated for the frame. Then, the training unit 16 stores the trained machine learning model 20 in a predetermined storage area of the machine learning device 10, and ends the machine learning processing.

Next, the estimation processing illustrated in FIG. 7 will be described.

In step S20, the estimation unit 18 acquires the estimation target video input to the machine learning device 10. Next, in step S22, the estimation unit 18 inputs the estimation target video to the trained machine learning model 20, estimates the motion indicated by each frame included in the estimation target video, outputs the estimation result, and the estimation processing is terminated.

As described above, the machine learning device according to the present embodiment uses, as the training video, the video in which the label indicating the type of the motion is added to the representative frame included in each section divided for each type of the motion of the person in the video including the plurality of frames. The machine learning device generates a combined label obtained by combining the first label and the second label for each frame between the first representative frame to which the first label is added and the second representative frame to which the second label is added in the training video. Then, the machine learning device trains the machine learning model so as to maximize the probability that the label of each frame estimated by the machine learning model is the first label or the second label included in the combined label generated for each frame. Thus, it is possible to improve the accuracy of the machine learning model for estimating a motion of a person in a video without performing the full annotation.

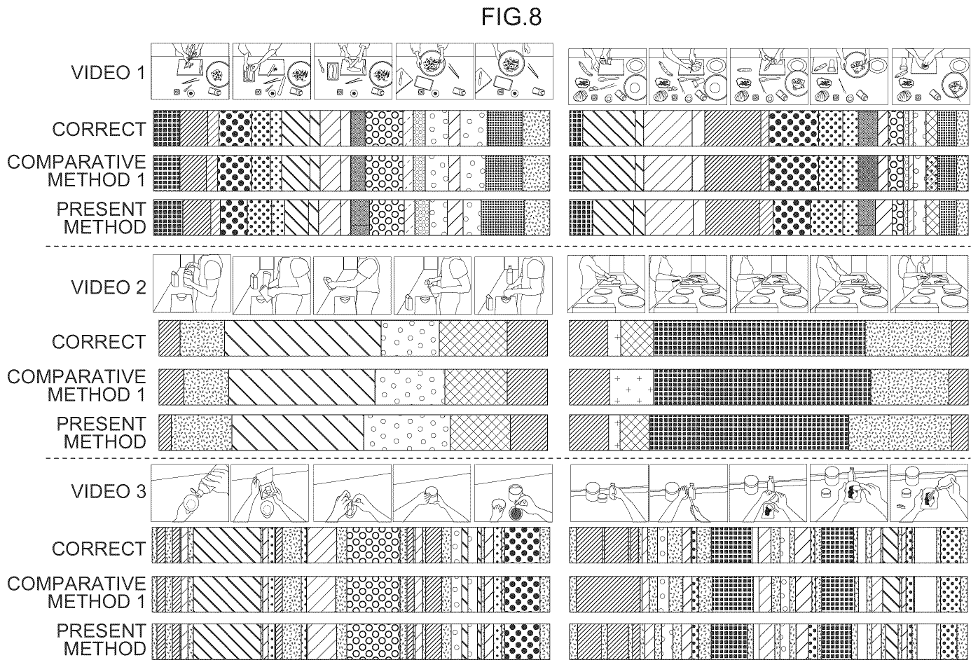

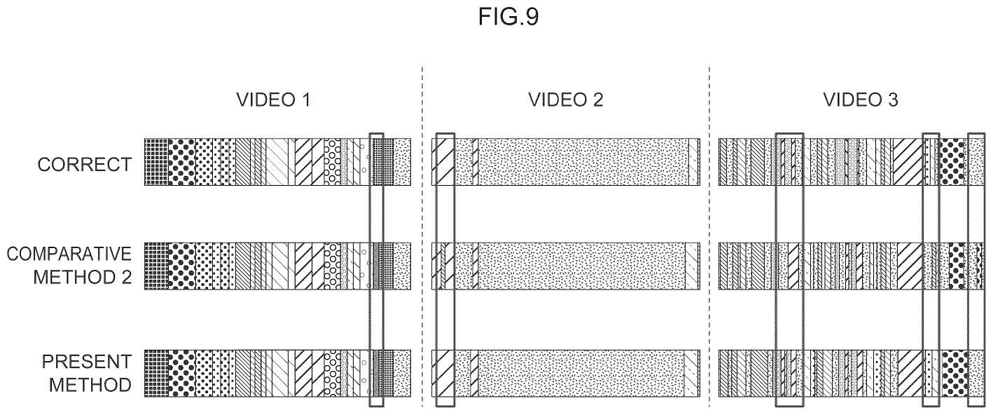

FIG. 8 illustrates a comparison result among a correct label, a label estimated by Comparative Method 1, and a label estimated by the technique of the present embodiment (hereinafter, referred to as “the present technique”) for each of videos 1 to 3. In FIG. 8, as in FIGS. 2 to 4 described above, differences in labels are represented by differences in hatching. The same applies to FIG. 9 described later. Comparative Method 1 is a method of training a machine learning model using a training video to which a label is added by a full annotation. The estimation result of the present method is very close to the correct answer, and the estimation accuracy to the extent of being an allowable range for use as an application is obtained.

FIG. 9 illustrates a comparison result among the correct label, the label estimated by Comparative Method 2, and the label estimated by the present technique for each of the videos 1 to 3. Comparative Method 2 is the timestamp semi-supervised learning. In particular, it can be seen that the estimation accuracy is improved in this method as compared with Comparative Method 2 in a portion surrounded by a thick line frame in FIG. 9 and the like.

In the above embodiment, the case in which the motion indicated by the label having the maximum probability is output as an estimation result has been described, but the embodiment is not limited thereto. The probability that the label indicating the motion of each frame that is the output of the machine learning model is each of the plurality of labels, that is, Y[i, f] may be output as the estimation result.

In the above embodiment, the case in which the machine learning unit and the estimation unit are configured by one computer has been described, but the machine learning unit and the estimation unit may be configured by different computers.

The above-described embodiment can be applied to, for example, interaction between a human and a robot. Specifically, the robot captures a motion of a human with a camera, and estimates the motion of the human from the captured video using the machine learning model trained as in the above embodiment. Then, the robot is controlled to support a human action or imitate a human action according to the estimated action.

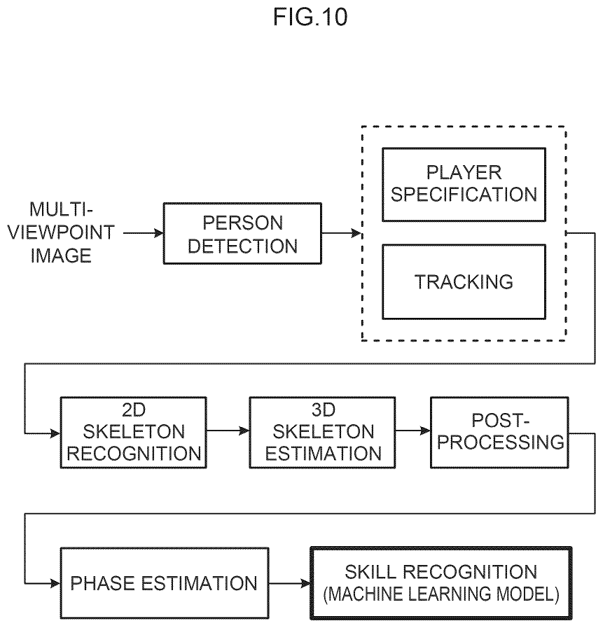

The above-described embodiment can be applied to, for example, a scoring system of a gymnastics competition. Here, an outline of a processing example of the scoring system of a gymnastics competition will be described with reference to FIG. 10.

When a multi-view image obtained by capturing an object from a plurality of different viewpoints is input, the scoring system detects a region of a person from each image included in the multi-viewpoint image. The scoring system tracks a person by associating regions indicating the same person among a plurality of frames of a single viewpoint in time-series multi-viewpoint images. It is determined whether the person indicated by the detected area is a player or a person other than a player, the area indicating the player is specified, and the tracked player is associated between a plurality of viewpoints, that is, between images. The scoring system recognizes two-dimensional skeleton information of the player from each of the tracked series of images using a recognition model or the like. The scoring system estimates three-dimensional skeleton information from the two-dimensional skeleton information using the camera parameters. Then, the scoring system performs post-processing such as smoothing on the time-series three-dimensional skeleton information, estimates the phase (break) of the performance, and then recognizes the skill. A machine learning model trained by the machine learning device according to the above embodiment can be applied to the recognition of this technique.

Application of the disclosed technology is not limited to the above-described human-robot interaction, gymnastics scoring system, and the like, and can be applied as a general motion recognition application.

In the above embodiment, the machine learning program is stored (installed) in the storage device in advance, but the embodiment is not limited thereto. The program according to the disclosed technology may be provided in a form stored in a storage medium such as a CD-ROM, a DVD-ROM, or a USB memory.

In the related art described above, there is a problem that the machine learning model trained with the training data of the timestamp annotation is inferior in accuracy to the machine learning model trained with the training data of the full annotation.

According to the disclosed technology, it is possible to improve the accuracy of a machine learning model for estimating a motion of a person in a video without performing the full annotation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory recording medium storing a program executable by a computer to perform machine learning processing, the processing comprising:
generating a combined label obtained by combining a first label and a second label for each of frames between a first representative frame to which the first label is added and a second representative frame to which the second label is added, in a video in which a label indicating a type of a motion of a person is added to a representative frame included in each section divided for each type of the motion of the person in the video including a plurality of frames; and
training a machine learning model, which estimates a label of each frame included in an input video, to maximize a probability that the label of each frame estimated by the machine learning model is the first label or the second label included in the combined label generated for each of the frames.

2. The non-transitory recording medium of claim 1, wherein:
the machine learning model estimates a probability that a label of each frame is each of a plurality of labels indicating a type of the motion by a value from zero to one, and
processing of the training the machine learning model includes minimizing a loss function that becomes smaller as a sum of a probability that a label of a frame in which the combined label is generated is the first label and a probability that the label is the second label is closer to one.

3. The non-transitory recording medium of claim 1, wherein processing of the generating the combined label includes generating the combined label by adding the first label to each frame from the first representative frame toward the second representative frame up to a frame immediately before the second representative frame, adding the second label to each frame from the second representative frame toward the first representative frame up to a frame immediately before the first representative frame, and combining a plurality of labels added to each frame.

4. The non-transitory recording medium of claim 2, wherein the processing further comprises:
in a case in which a video to be estimated with a label is input to the trained machine learning model, outputting, as the label of each frame, a label having a maximum probability that a label of each frame is each of the plurality of labels, the label being estimated by the machine learning model for each frame of the video to be estimated.

5. A machine learning method executable by a computer to perform a process, the process comprising:
generating a combined label obtained by combining a first label and a second label for each of frames between a first representative frame to which the first label is added and a second representative frame to which the second label is added, in a video in which a label indicating a type of a motion of a person is added to a representative frame included in each section divided for each type of the motion of the person in the video including a plurality of frames; and
training a machine learning model, which estimates a label of each frame included in an input video, to maximize a probability that the label of each frame estimated by the machine learning model is the first label or the second label included in the combined label generated for each of the frames.

6. The machine learning method of claim 5, wherein:
the machine learning model estimates a probability that a label of each frame is each of a plurality of labels indicating a type of the motion by a value from zero to one, and
processing of the training the machine learning model includes minimizing a loss function that becomes smaller as a sum of a probability that a label of a frame in which the combined label is generated is the first label and a probability that the label is the second label is closer to one.

7. The machine learning method of claim 6, wherein processing of the generating the combined label includes generating the combined label by adding the first label to each frame from the first representative frame toward the second representative frame up to a frame immediately before the second representative frame, adding the second label to each frame from the second representative frame toward the first representative frame up to a frame immediately before the first representative frame, and combining a plurality of labels added to each frame.

8. The machine learning method of claim 6, wherein the processing further comprises:
in a case in which a video to be estimated with a label is input to the trained machine learning model, outputting, as the label of each frame, a label having a maximum probability that a label of each frame is each of the plurality of labels, the label being estimated by the machine learning model for each frame of the video to be estimated.

9. A machine learning device, comprising:
a memory; and
a processor coupled to the memory, the processor being configured to execute processing, the processing including:
generating a combined label obtained by combining a first label and a second label for each of frames between a first representative frame to which the first label is added and a second representative frame to which the second label is added, in a video in which a label indicating a type of a motion of a person is added to a representative frame included in each section divided for each type of the motion of the person in the video including a plurality of frames; and
training a machine learning model, which estimates a label of each frame included in an input video, to maximize a probability that the label of each frame estimated by the machine learning model is the first label or the second label included in the combined label generated for each of the frames.

10. The machine learning device of claim 9, wherein, in the processing:
the machine learning model estimates a probability that a label of each frame is each of a plurality of labels indicating a type of the motion by a value from zero to one, and
processing of the training the machine learning model includes minimizing a loss function that becomes smaller as a sum of a probability that a label of a frame in which the combined label is generated is the first label and a probability that the label is the second label is closer to one.

11. The machine learning device of claim 9, wherein, in the processing:
processing of the generating the combined label includes generating the combined label by adding the first label to each frame from the first representative frame toward the second representative frame up to a frame immediately before the second representative frame, adding the second label to each frame from the second representative frame toward the first representative frame up to a frame immediately before the first representative frame, and combining a plurality of labels added to each frame.

12. The machine learning device of claim 10, wherein the processing further comprises:
in a case in which a video to be estimated with a label is input to the trained machine learning model, outputting, as the label of each frame, a label having a maximum probability that a label of each frame is each of the plurality of labels, the label being estimated by the machine learning model for each frame of the video to be estimated.
